(19) United States
(12) Patent Application Publication
(10) Pub. No.: US 2002/0140130 A1
(43) Pub. Date: Oct. 3, 2002

(54) Method and apparatus for reconditioning a shipping container

(76) Inventors: Andrei Stefanescu, O'Fallon, MO (US); Julie Brangenberg, Alton, IL (US); James Duly, St. Charles, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/769,773

(22) Filed: Jan. 25, 2001

(51) Int. Cl. B29C 61/00

(52) U.S. Cl. 264/320; 425/11

(57) ABSTRACT

A method of and apparatus for reconditioning deformable shipping container fingers used to transport silicon wafers by reforming the fingers to a desired position with or without the use of heat. The apparatus is specifically biased for proper positioning in the shipping container such that the fingers will be fixtured into the desired position. Use of heat in the fixturing process minimizes the amount of time necessary for the fingers to acquire the desired positioning.

### BACKGROUND OF THE INVENTION

This invention relates in general to reconditioning of a deformable container for repeated use, and particularly to a method of and apparatus for reconditioning deformable shipping container fingers by reforming the fingers to a desired position with or without the use of heat. Within the wafer industry, it is common to store and ship wafers in an shipping container. Ultrapak® containers and cassettes are manufactured by Empak, Inc. of Colorado Springs, Colo. using polypropylene as a starting material. As Ultrapak® containers are low in cost, no considerable effort has been made for the reuse of the package up until now.

These containers hold the wafers in cassette that fits within the container and is specially designed to securely hold the wafers. The cassette holds up to wafers. The container itself is comprised of a top and a bottom. When correctly assembled, the three components store and immobilize the cassette loaded with wafers. Fingers molded to the top of the container assembly have a special profile for urging the wafers down into the cassette slots. The fingers provide a key role in avoiding any breakage, rotation, cross-slotting or “rattling” of wafers during their transport. Movement of the wafers in the container can generate particles which can contaminate all of the wafers.

One of the main obstacles in the reuse of an Ultrapak® container is the loss of the finger tension/elasticity and alignment as a result of any prior wafer storage. Even after a few hours of storage, the fingers loose their elasticity and after opening of the container, they never return to the original, aligned position. Current practice in the industry is to discard the container after a single use, due to the belief it cannot be reused because of the lost elasticity of the fingers. Alternatively, some designs have replaceable fingers. The Ultrapk® does not have replaceable fingers. This would result in lower particle performance of the entire package assembly during wafer transport. Wafer shipping containers must be washed prior to their first use in order to eliminate particles, which affect the quality of the wafers. Wafers are eventually processed into computer chips, and any particle contamination of the wafer results in increased probability that some chips will have to be discarded due to the contamination. It is common to measure the number of particles on a wafer to monitor and measure the efforts to eliminate contamination.

A single wafer shipping container consists of three pieces: (1) a cassette for holding wafers; (2) a top half of the container; and (3) a bottom half of the container. The cassette has slots for placement of the wafers. The top half of the container has “fingers” which correspond to the slots in the cassette. When assembled, the cassette, container top and container bottom encase and immobilize the wafers and cassette, readying the package for transport. Fingers inside the container top press against the individual wafers, retaining the wafers from undue movement within the cassette slots. Retaining the wafers within the slots helps inhibit breakage, rotation, cross-slotting, or rattling of the wafers during transport.

Wafer shipping containers of the type described are widely used in the semiconductor industry for packaging and shipping semiconductor wafers. The containers may be formed from polypropylene (a well-known and highly used plastic material of relatively low cost), or any other suitable material. After the first storage of wafers in the container, the fingers deform and bend upwards by engagement with the wafers. After deformation, the containers are no longer useful as the fingers no longer adequately retain the wafers in place for storage and transportation. The particle performance of the entire container is compromised, making the container unusable. As such, the container and cassettes are rarely used more than once, although interest in reuse of these containers has recently grown. A process whereby used wafer shipping containers and other boxes of this type, could be reconditioned for use would be advantageous and beneficial.

### SUMMARY OF THE INVENTION

Among the several objects and features of the present invention may be noted the provision of a device and a process for reconditioning wafer shipping containers for reuse; the provision of such a device and process which restore functionality to resilient retaining portions of the container; the provision of such a device and process which reposition the retaining portions in the container after plastic deformation; the provision of such a device which is simple to make and use; the provision of such a device which can hold up under different process conditions such as heat treatment and washing of the container; the provision of such a device which is capable of being easily placed and removed within the container; the provision of such a device sized such that it will place the retaining portions of the container in the proper position when fitted properly into the container top; and the provision of such a process which can be carried out simultaneously with other container reconditioning processes.

A method of the present invention is for reconditioning deformed retaining portions of a container used for positioning articles in the container by application of a resilient holding force on the articles. The fingers have a deformation history through prior use of the retaining portions to hold articles in the container such that at least some of the retaining portions are no longer capable of applying the same resilient holding force to the articles. This method generally comprises the steps of: (1) fixturing the retaining portions by placement of a fixture to hold the retaining portions in a position selected to substantially restore the function of the retaining portions to be able to apply a resilient holding force to articles in the container, and (2) substantially erasing the deformation history of the retaining portions by holding the retaining portions in said selected position until the retaining portions are reconditioned for use to be able to apply said resilient holding force to articles in the container.

In another aspect of the present invention, a device for fixturing the aforementioned resilient fingers of a container generally comprises means for placing the fingers in a position to recondition retaining portions deformed from the use of holding articles to a recycled condition capable of applying a selected holding force for holding articles in the container. Also, the devise comprises means for holding the placing means in self-retained position against the fingers.

In still another aspect of the present invention, a device for fixturing the aforementioned resilient retaining portions of a container. The device comprises a first positioning member sized and shaped for placement between the retaining portions and a portion of the container for separating a first group of the retaining portions and one container portion to position the first group of retaining portions in a proper position to recondition the retaining portions. It also has a second positioning member sized and shaped for placement between the retaining portions and another portion of the container for separating a second group of the retaining portions and another container portion to position the second group of retaining portions in a proper position to recondition the retaining portions. There is a connector connecting the first and second positioning members.

Other objects and features will be in part apparent and in part pointed out hereinafter.

### BRIEF DESCRIPTION OF THE DRAWINGS

FIG. 1 is a perspective of a container used to ship semiconductor wafers with a top of the container exploded and partially cut away to show the fingers in the container lid which retain the wafers when wafers are stored in the container;

FIG. 2 is a transverse section of the container in a closed and sealed configuration and holding a wafer;

FIG. 3 is an enlarged fragment of FIG. 2 illustrating a desired undeflected position of the fingers in phantom along with a wafer stored in a slot;

FIG. 4 is an enlarged fragment similar to FIG. 3, but with the wafer removed and illustrating a device for fixturing the fingers of the present invention;

FIG. 5 is an enlarged fragment similar to FIG. 4 but illustrating a device of a second embodiment;

FIG. 6 is a plan view of the device of the first embodiment of the invention, with parts broken away to show a spring within the H-shaped device;

FIG. 7 is a top plan view of the second embodiment of the invention.

Corresponding reference characters indicate corresponding parts throughout several views of the drawings;

FIG. 8 graphs the force applied by the resilient retaining portions of a container over time, showing the results for an unused container, a used and retensioned container, and a container used twice without retensioning container;

FIG. 9 shows the deflection of the resilient retaining portions of a container as a function of force for a reused and retensioned container, a container used once only, and a contained reused twice; and

FIG. 10 illustrates the point on a finger where the tensioning portions of the container were measured to prepare FIGS. 8 and 9.

Corresponding reference characters indicate corresponding parts throughout the several views of the drawings.

### DETAILED DESCRIPTION OF THE PREFERRED EMBODIMENTS

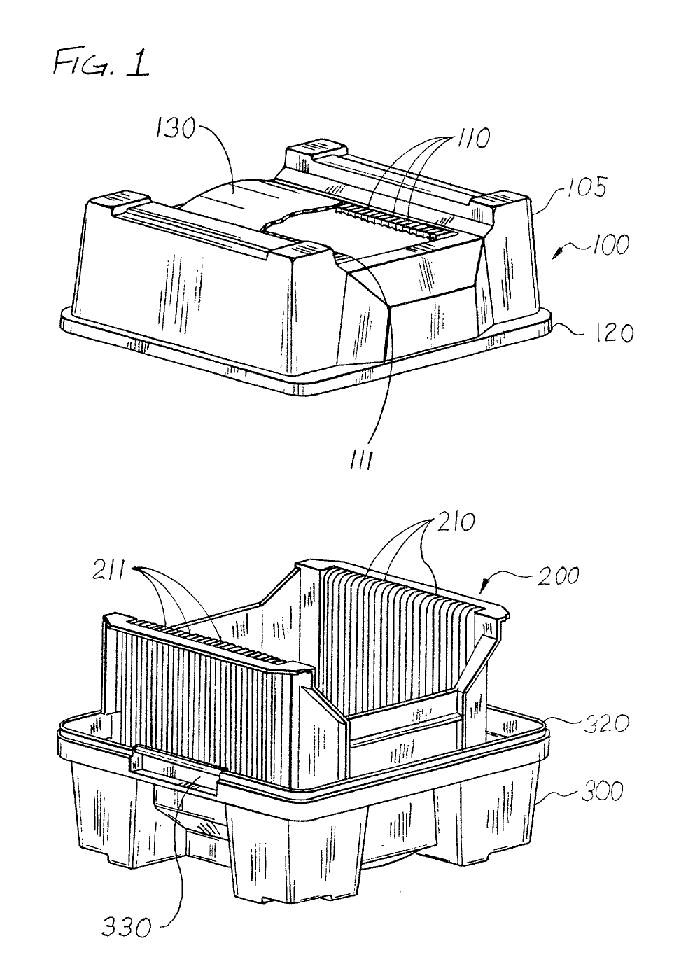

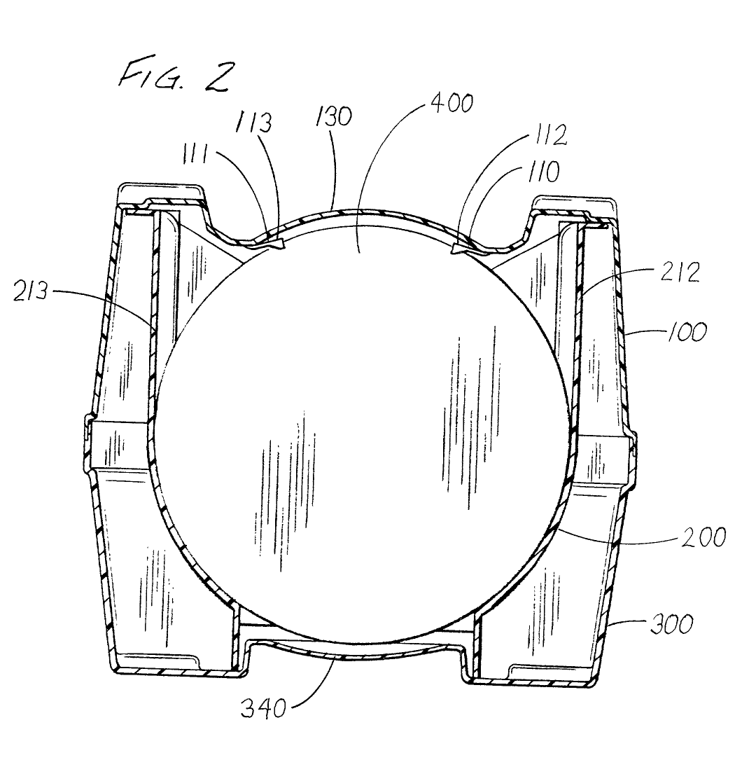

Referring now to the drawings, FIG. 1 shows a container (generally indicated at 100) used to store and transport any kind of a thin, flat object, but particularly a wafer used to produce semiconductor chips. Container 100 includes a top 105 having a curved upper surface 130 and a fitted edge 120 that forms a tight seal with the bottom of the container 300. Fingers 110 and 111 (broadly, “retaining portions”) are opposed and aligned so that the upper portions of individual wafers will fit between opposing pairs of fingers. In the illustrated embodiment, the fingers 110, 111 are formed as one piece with the container top 105. The distal ends of the fingers 110 are bifurcated into tip portions 112 and the distal ends of the fingers 111 are bifurcated into tip portions 113. Only one of the tip portions 112, 113 of the fingers 110, 111 can be seen in FIG. 2, the other of the tip portions being located on the opposite side of the wafer 400. A gap (not shown) between the tip portions 112, 113 of each finger receives a short peripheral request of the wafer 400. A cassette 200 fits within the bottom of the container 300. The cassette has rows of opposing grooves 210 and 211 in which individual wafers may be placed. The cassette 200 is open at the bottom. The bottom of the container 300 is curved in general conformance with the shape of the peripheries of the wafers stored in the container 100. The bottom of the container 300 has a lip 320 that runs around the edge of the bottom of the container, and seals with the fitted edge 120 of the top of the container 100. The illustrated container is the ULTRAPAK® shipping container commercially available from the Empak, Inc. of Colorado Springs, Colo.

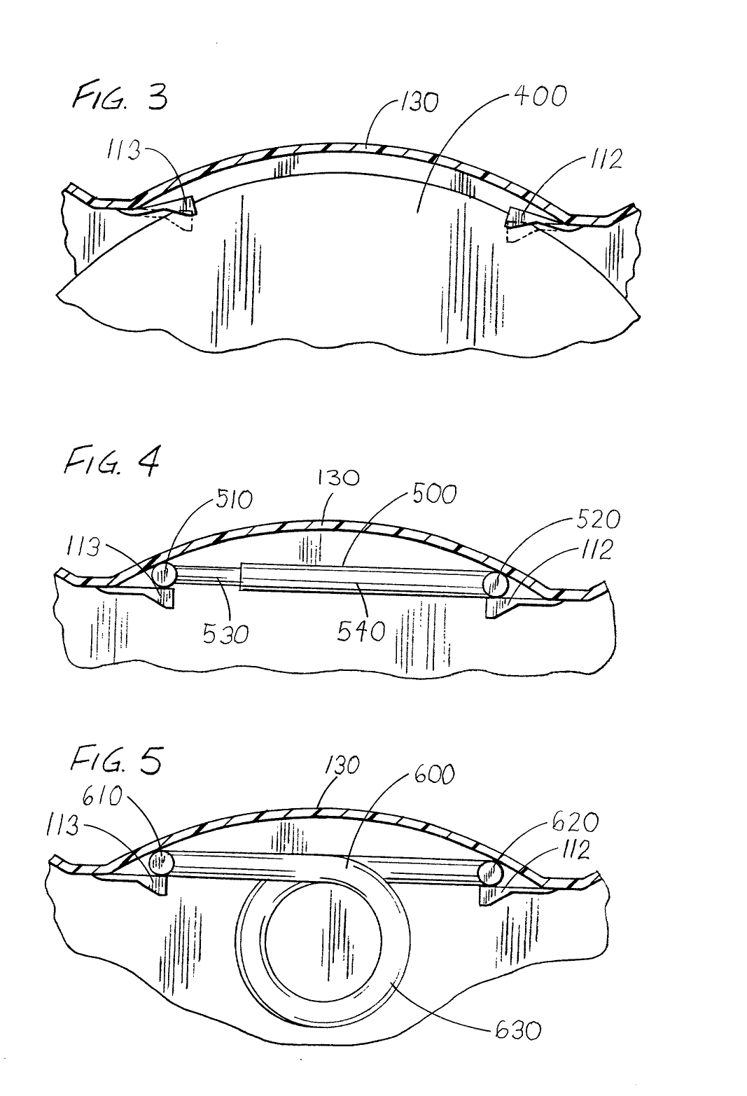

A wafer 400 fits snugly within the container. The wafer 400 is tightly held within a single row formed by an aligned pair of the grooves 210, 211 designated at 212 and 213, respectively. Transversely opposed pairs of fingers 110, 111 engage each wafer 400 with one tip portion 112, 113 disposed on one side of the wafer and the other tip portion disposed on the other side of the wafer. Engagement with the wafer 400 deflects the fingers 110, 111 upwardly from their initial relaxed positions, illustrated in phantoms in FIG. 3. The fingers 110, 111 resist the deflection and bear against the wafer 400, holding it down in the grooves 212, 213 and resisting movement of the wafer relative to the container 100 and the other wafers in the container. Curved top 130 of the container and curved bottom 340 of the container provide adequate room in the container to fit the profile of the circular wafer 400. After storing a wafer for only a brief time, the fingers 110 and 111 become plastically deformed. In this case, the fingers are not positioned correctly (the phantom lines in FIG. 3 indicate proper positioning) to retain the semiconductor wafer in place for safe shipment and/or storage.

According to the present invention, a reconditioning device 500 can be positioned to recondition all of the deformed fingers 110, 111. In a first preferred embodiment, the device 500 has a generally “H” shape (see FIG. 6), including a pair of legs 510, 520 joined together by a cross piece generally indicated at 522 (FIG. 4). A first element 530 of the cross piece 522 is fixedly joined to leg 522 and telescopingly received in a tubular second element 540 fixedly joined to leg 520. A coil compression spring 540 disposed in the second element 540 has end caps 542 receiving the ends of the spring. One of the end caps engages the leg 520 and the other end cap engages the free end of the first element 530, biasing the first element 530 outward of the second element 540 and, accordingly, urging the legs 510, 520 apart from each other. Referring to FIG. 4, the device 500 can be compressed, moving the legs 510, 520 closer together so that the device can be moved upwardly between the opposing rows of fingers 110, 111 and released so that the legs move outwardly between the upper surface 130 of the top 105 of the container 100. The legs 510, 520 are disposed between the curved upper surface 130 and the fingers 110, 111, pushing the fingers downward. The spring 530 allows the device 500 to hold itself in a self-retained position (shown in FIG. 4) in the top 105. The force of the spring 540 and the diameter of the legs 510, 520 are selected so that the fingers 110, 111 are relocated to a position at or slightly below their original, undeformed positions. A more detailed discussion of the method of the present invention employing the device 500 will be described hereinafter.

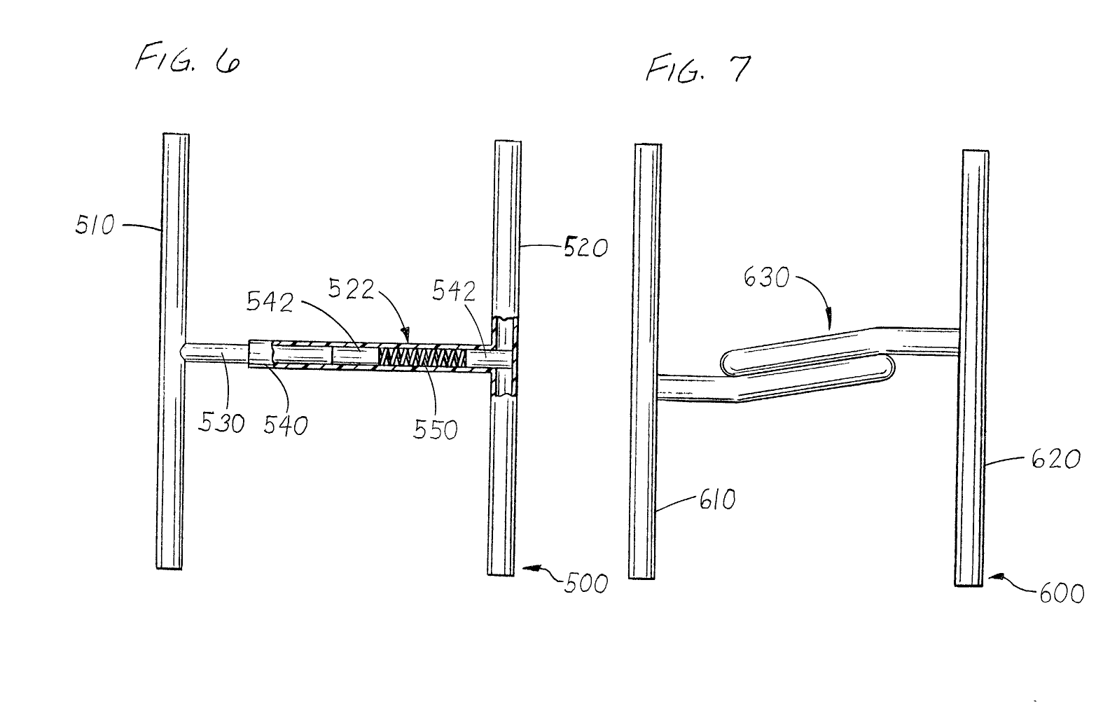

A second embodiment of the device (designated generally at 600) is shown in FIG. 7 to comprise legs 610, 620 similar to the legs 510, 520 of the device 500 of the first embodiment. However, the legs 610, 620 are joined together by a torsion spring 630 having a first end connected to the leg 610 and a second end connected to the leg 620. In a relaxed condition of the spring 630, the legs 610, 620 are located relatively closer together so that they may be passed upwardly between the opposed rows of fingers 110, 111. Counter rotation of the legs 610, 620 about the axis of the spring 630 moves the legs further apart so that they fit between the fingers 110, 111 and the curved upper surface 130 of the top 105 forcing the fingers down to the position at or slightly below their original, undeformed position. The torsion induced in the spring 630 by the counter rotation of the legs 610, 620 causes the legs to be biased outwardly against the surface 130 of the top 105 of the container 100. Thus, the device 600 is capable of retaining itself in position on the top 105.

Having described the device (500, 600) of the present invention, a preferred method of use will be described. Reforming the fingers 110, 111 to substantially their initial positions after use is ideally done during the normal wash cycle of the container 100. The container is washed in any event before the initial and every subsequent use of the container to reduce the potential for contaminating the wafers. After the first and every subsequent use, the fingers 110, 111 will be permanently deformed from their initial positions, thus defining fingers having a “deformation history”. In this deformed position, some or all of the fingers 110, 111 are not capable of applying the same resilient holding force that they did when in their original undeformed positions. The method of the present invention substantially erases the deformation history so that the fingers 110, 111 can apply nearly the same resilient holding force to subsequent wafers.

The fingers 110, 111 are first fixtured in a position which is at or slightly beyond their original undeflected position by inserting the legs (510, 520 or 610, 620) of the device (500 or 600) between the fingers and the curved upper surface 130 of the top 105. Although either device (500 or 600) could be used, the remainder of the description will assume device 500 is being used for simplicity. The top 105 with the device 500 is then subjected to a normal wash in which the temperature is about 50° to 60° C. The heat of the wash substantially removes the stress of the fingers 110, 111 as deflected by the device 500 back to their original positions. The container top 105 is brought back down to room temperature with the device 500 remaining in place to locate the fingers. Thereafter, the device is removed and the container 100 is ready for reuse. Instead of raising the temperature of the box, the device 500 could be left in the top 105 for longer periods of time (in a clean room environment) to achieve the desired repositioning of the fingers 110, 111. Of course, the reconditioning process will take substantially longer (e.g., several days) in the latter instance.

Containers 100 of the preferred embodiment (i.e., an ULTRAPAK® shipping container) are made primarily of polypropylene having a glass transition temperature of about −10° C. While not bound by the following theory, it is generally believed that using the device above the glass transition temperature of the plastic leads to satisfactory results. For example, the reformation of the fingers 110, 111 using the device 500 which is carried out at a temperature of 45°-60° for a period of about 10 minutes produces satisfactory results. The times and temperatures experienced by the container top 105 in the standard Atcor wash cycle designed for particulate removal are sufficient to produce the desired repositioning of the fingers 110, 111. The following examples illustrate the efficacy of the device 500 and method of the present invention.

### EXAMPLE 1

### Visual Verification of the Realignment in Different Times and Conditions

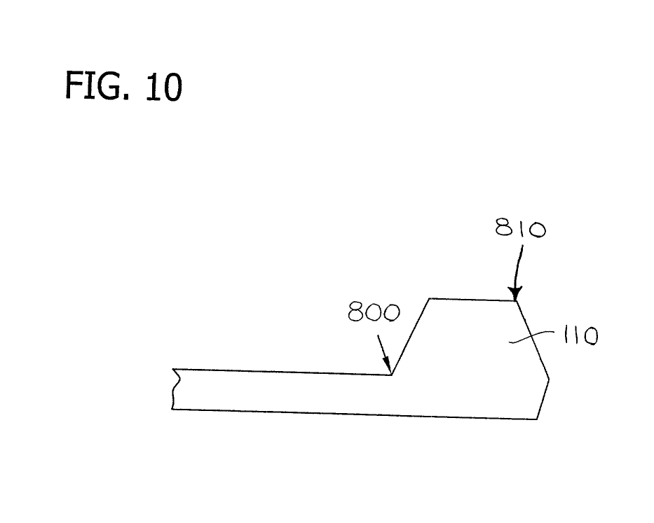

Two Ultrapak® shipping containers 100 were tested. Nine wafers were loaded in slots 1-3, 11-13 and 23-25 of the two containers. Both containers were stored for approximately one week. After unloading the wafers, the amount of deflection was measured at the end of the used fingers. The average deflection was approximately 100 thousandth of an inch per container (2.5 mm) as measured at location 810 in FIG. 10. Next, the containers were washed in a standard Atcor washer, one container having the device 500 of FIG. 6 and one without the device. After removing the device from the “fixtured” top 105, the alignment of the fingers was checked visually. Although the deflection of the fingers of the non-“fixtured” box has also decreased, only in the case of the fingers that were “fixtured” using the device 500 during the wash cycle, was complete realignment achieved. No notable change in the position of the realigned fingers was observed even several weeks after the insert removal.

### EXAMPLE 2

### Comparative Measurements of the Finger Tension

Alignment and elasticity of the fingers through the “fixturing” process was measured. Two 200 mm Ultrapak® shipping containers 100 were loaded with nine wafers each (slots 1-3, 12-14 and 23-25) and stored at room temperature for 6 days. After this storage interval and after unloading the wafers, the fingers corresponding to the wafer occupied slots were visibly out of alignment from the standard position. The deflections ranged between 30-50 thousandths of an inch (0.76-1.27 mm) as measured at location 800 in FIG. 10. Next, both boxes were subjected to a normal Atcor cleaning cycle, with one of the boxes having the fingers “fixtured” with the device of FIG. 6.

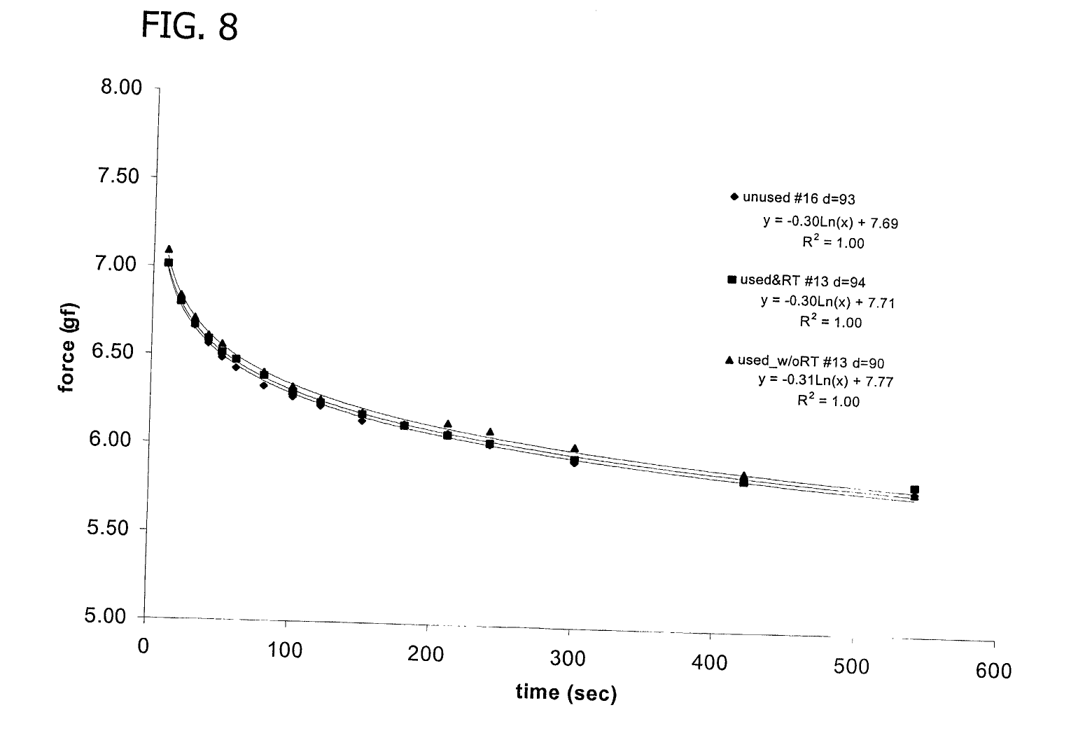

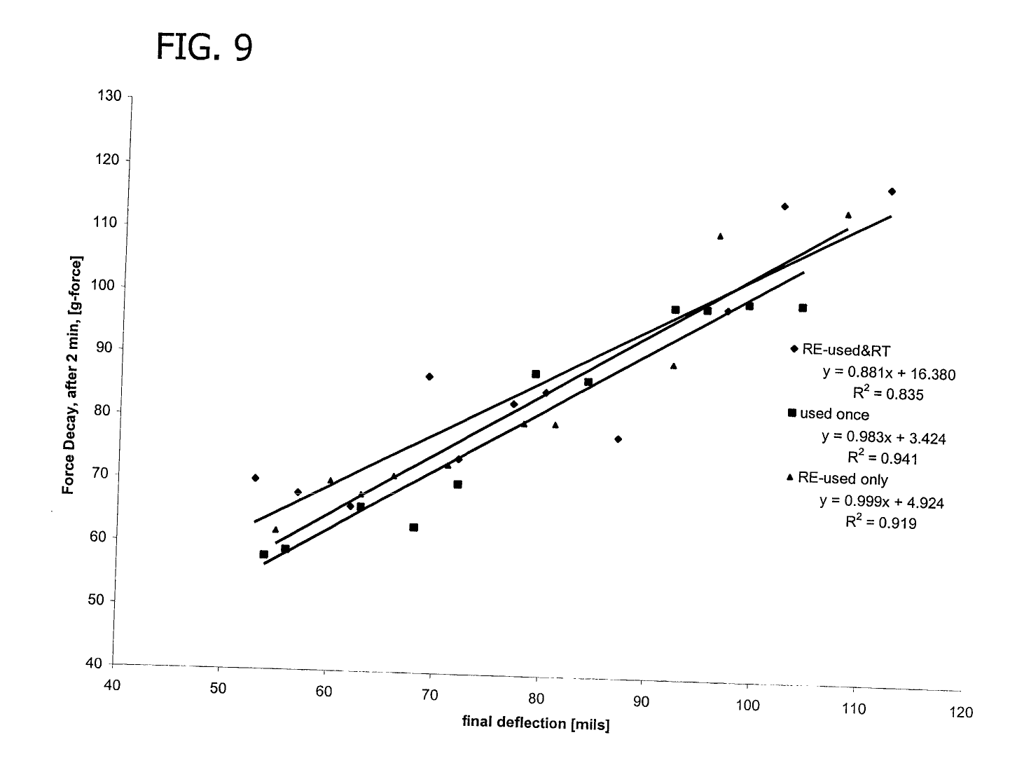

After removing the insert, all the fingers were aligned and apparently were capable of retaining that position for times as long as 72 hours. Then, dummy wafers were loaded in both containers and they were staged at room temperature for 6 days. The results on the elasticity decay for the 3 sets of fingers, “Used Once”, “Reused and retensioned” and “Reused Only” are shown in FIGS. 8 and 9. In one test, one finger from each group was deflected by 90-93 thousandths of an inch (2.28-2.36 mm) as measured at location 800 in FIG. 10 by pressing with the probe of an Imada DPS11R force gauge. The decay of the reactive stress of the finger was measured. The differences between the decays for all the finger groups were not significant. Next, the fingers were pressed down, reaching a constant deflection value, and the reactive tension of the finger was monitored at different time intervals. In FIG. 9 the average results of 11 fingers tested from each of the “Used Once”, “Reused and retensioned” and “Reused Only” groups is given. The remaining reactive tension in each of the fingers was recorded at 2 minutes after the stress was applied at different deflection values. All the measurements were made by applying the stress with the tip of the Imada probe at the point indicated in the FIG. 10.

The test results indicate that there is no statistical difference between the three sets of measurements.

### EXAMPLE 3

### Particle Performance of the Reused Boxes with Realigned and Retensioned Fingers

This test monitored the particle performance for three 200 mm Ultrapak® containers:

CASE A: Control

A standard Ultrapak® shipping container was washed using the normal Atcor conditions and then placed into use.

CASE B: Reused Ultrapak®

A standard Ultrapak® shipping container was loaded with 9 dummy wafers and stored for one week in a cleanroom. After unloading the wafers, the package was washed using the normal Atcor conditions. It was then reloaded with wafers and reused a second time. The fingers were deflected from the first use.

CASE C: Reused and Retensioned Ultrapak®

A standard Ultrapak®) shipping container was loaded with 9 dummy wafers and stored for 1 week in the cleanroom. After unloading the wafers, the container was washed in Atcor with the fingers “fixtured” in the realigned position using the device of FIG. 6.

Next, 75 wafers were scanned on a KLA-Tencor SP-1 auto-inspection tool using a 0.12 mm threshold particle recipe. The wafers were loaded into the three boxes, which after bagging, were transported to a cleanroom, where they were unpackaged and stored for approximately 3 days.

The boxes were re-bagged and sent to their original packaging site, where they were re-inspected in the same conditions. After this storage and handling interval, which took 1 week, the wafers were re-scanned in the same conditions. In all three cases (A-C) the top of the boxes had the fingers equally deflected.

The particle performance of handling and storing the wafers in each case A-C was evaluated by 2 methods (see Table 1): 1) the total particle counts were counted and compared before and after the handling and storage; 2) using Excel macros, particles on the same wafers, before and after handling and storage were matched by location, and the new “Added Particle” counts were calculated and used in the comparison. This later comparison method allowed comparison of the newly “Added” and “Moved” particles, eliminating the impact of “Totally Removed” particles from the wafer surface during the process. By both evaluation methods, the best particle performance was found on Case C—Reused and Retensioned.

The repeated ability to reuse and rewash containers helps to continuously remove particles from the inside of the container, thus making it more difficult for contamination.

TABLE 1
Particles found on test wafers before and after storage and handling
in new and reused Ultrapak® boxes

| | | | Case | | Case C (Reused | |
|---|---|---|---|---|---|---|
| | Case A (Control) | | B (Reused) | | and Retensioned) | |
| Counts | Total | Per/wafer | Total | Per/wafer | Total | Per/wafer |
| Initial | 688 | 27.52 | 849 | 33.96 | 252 | 10.08 |
| Particles | | | | | | |
| Final | 688 | 27.52 | 853 | 34.12 | 247 | 9.88 |
| Particles | | | | | | |
| Initial-Final | 0 | 0 | 4 | 0.16 | −5 | −0.2 |
| Standard | — | 10.00 | — | 11.25 | — | 9.24 |
| Deviation | | | | | | |
| Matching | 687 | 27.48 | 847 | 33.88 | 242 | 9.68 |
| Particles | | | | | | |
| Added | 44 | 1.76 | 43 | 1.72 | 5 | 0.2 |
| Particles | | | | | | |

In view of the above, it will be seen that the several objects of the invention are achieved and other advantageous results attained.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A method of reconditioning deformed article retaining portions of a container used for positioning articles in the container by application of a resilient holding force on the articles, the retaining portions having a deformation history through prior use of the retaining portions to hold articles in the container such that at least some of the retaining portions are no longer capable of applying the same resilient holding force to the articles, the method comprising the steps of fixturing the retaining portions by placement of a fixture to hold the retaining portions in a position selected to substantially restore the function of the retaining portions to be able to apply a resilient holding force to articles in the container, and substantially erasing the deformation history of the retaining portions by holding the retaining portions in said selected position until the retaining portions are reconditioned for use to be able to apply said resilient holding force to articles in the container.

2. A method as set forth in claim 1 wherein the step of substantially erasing the deformation history includes holding the retaining portions in said selected position for a preset amount of time to substantially eliminate the deformation history.

3. A method as set forth in claim 2 wherein the step of substantially erasing the deformation history further includes the steps of heating the retaining portions until the deformation history is substantially erased and then cooling the retaining portions.

4. A method as set forth in claim 3 wherein the retaining portions have a glass transition temperature, and are heated to a temperature at least equal to the glass transition temperature thereof for a time sufficient to erase the deformation history of said box top retaining portions and then subsequently cooled.

5. A method as set forth in claim 4 further comprising the step of removing the fixture from contact with the retaining portions after the deformation history is substantially erased.

6. A method as set forth in claim 4 wherein said step of heating the retaining portions comprises subjecting the container including the retaining portions to a wash cycle to remove particulates in the container following its use to hold articles, which wash cycle raises the temperature of the retaining portions.

7. A method as set forth in claim 6 wherein said step of a wash cycle raises the temperature of the retaining portions above the glass transition temperature of said retaining portions.

8. A method as set forth in claim 4 wherein the articles are semiconductor wafers, and wherein the method further comprises the step of placing the wafers in the container so that the wafers are engaged by the retaining portions for holding the wafers in spaced apart position during transportation and storage.

9. A method as set forth in claim 1 wherein the step of fixturing the retaining portions comprises locating a positioning member between the retaining portions and another portion of the container to force the retaining portions away from said container portion.

10. A device for fixturing article retaining portions of a container in which the retaining portions are capable of applying a resilient holding force to articles in the container to hold the articles in selected positions, the device comprising means for placing the retaining portions in a position to recondition retaining portions deformed from the use of holding articles to a recycled condition capable of applying a selected holding force for holding articles in the container, and means for holding the placing means in self-retained position against the retaining portions.

11. A device for fixturing article retaining portions of a container for holding articles in selected positions, in which the retaining portions are capable of applying a resilient holding force to articles in the container, the device comprising a first positioning member sized and shaped for placement between the retaining portions and a portion of the container for separating a first group of the retaining portions and one container portion to position the first group of retaining portions in a proper position to recondition the retaining portions, a second positioning member sized and shaped for placement between the retaining portions and another portion of the container for separating a second group of the retaining portions and another container portion to position the second group of retaining portions in a proper position to recondition the retaining portions, and a connector connecting the first and second positioning members.

12. A device for fixturing retaining portions as set forth in claim 11 wherein the connector is adapted to bias the first and second positioning members for holding the device in a self-retained position in the container.

13. A device for fixturing retaining portions as set forth in claim 11 wherein the first positioning member is generally T-shaped and includes a first crossing bar, first a hollow base bar and a biasing member located in said first base bar and wherein the second positioning member is generally T-shaped and includes a second crossing bar and a second base bar matingly connected to said first hollow base bar in said first T-shaped member and biased by said biasing member in a direction which would increase the distance between said first and second crossing bars.

14. A device for fixturing retaining portions as set forth in claim 13 wherein said first crossing bar and said second crossing bar are adapted to push deformed box top retaining portions into a selected position.

15. A method of recycling a shipping container for holding wafers having two rows of opposing article retaining portions designed to resiliently hold semiconductor wafers in a set position which are deformed from an original shape after holding the wafers for a period of time, consisting of the steps of:
repositioning said container retaining portions to the original shape; and
holding said container retaining portions in said original shape until said container retaining portions deform back to their original shape.

16. The method of claim 15, whereby said container retaining portions are heated after they are held in the original shape until said container retaining portions deform back into their original shape.

17. The method of claim 16, whereby said container retaining portions are cooled after they have been heated and deformed back into their original shape.

18. The method of claim 15, whereby said container retaining portions are heated to a temperature above the glass transition temperature thereof, but below the melting point of said container retaining portions.
